(19) United States
(12) Patent Application Publication
(10) Pub. No.: US 2009/0114039 A1
(43) Pub. Date: May 7, 2009

(54) APPARATUS AND METHOD FOR FINDING A DEVICE

(75) Inventors: Volkmar Schultze, Rutha (DE); Wilfried Andra, Jena (DE); Katja Peiselt, Jena (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Rayonex Schwingungstechnik GmbH, Lennestadt (DE)

(21) Appl. No.: 12/091,383

(22) PCT Filed: Oct. 14, 2006
(86) PCT No.: PCT/EP2006/009936

§ 371 Date: Oct. 1, 2008

(30) Foreign Application Priority Data
Oct. 25, 2005 (DE) 102005051357.3

(51) Int. Cl. G01B 7/00; G01F 1/05

(52) U.S. Cl. 73/861.77; 324/207.25

(57) ABSTRACT

An apparatus and a method for finding a device, whereby at least one magnetic dipole, arranged in the area of the device, rotates about a rotation axis extending at an angle of >0° to the device length axis, the three time-dependent magnetic-field components Hx(t), Hy(t) and Hz(t) are detected, and the position, the orientation of the device axis and/or the roll angle of the device is calculated from this.

The invention relates to an apparatus and a method for locating a device. In particular, the invention relates to medical instruments as well as drill heads and methods for locating medical equipments and drill heads.

U.S. Pat. No. 5,589,775 discloses a method for determining the distance and direction between a first borehole and a second borehole. A rotating magnet is hereby provided in a borehole and has a rotation axis which coincides with the length axis of the drill head and extends perpendicular to its own length axis. To determine the distance of the drill head in relation to the reference point situated in the rotation plane of the magnet and arranged in the second borehole, U.S. Pat. No. 5,589,775 teaches a measurement of the course of both orthogonal components of the magnetic filed vector which intersects the reference point. The distance between drill head and reference point as well as the angular disposition in the fixed coordinate system of the reference point can be determined on the basis of the course of both components.

As the magnet in the apparatus of U.S. Pat. No. 5,589,775 is securely fixed to the drill head so that a rotation of the magnet is dependent on a rotation of the drill head, it is disadvantageous that the distance as well as the alignment can be determined only when the drill rotates.

DE 102 25 518 B4 discloses therefore an apparatus and a method for determining a position of an instrument or device, whereby a magnetic dipole is arranged in the instrument or device to generate a magnetic filed which changes in time and is measured and evaluated to determine a position and orientation. To ensure a detection even when the device is stationary, DE 102 25 518 B4 proposes to rotate the magnetic dipole independent on a movement of the device housing. The independent rotational motions between housing and magnetic pole do no longer allow an inference about the roll angle of the housing on the basis of the determined orientation of the magnetic field.

The invention is therefore based on the object to improve on the methods and apparatuses known in the prior art. In particular, an apparatus and a method for locating a device should be provided which indicates the position in space, the orientation of a particular device axis as well as the roll angle of the device about this device axis.

This object is attained by an apparatus, a system, and a method according to the independent claims. Preferred embodiments are the subject matter of the subclaims.

The essence of the invention provides for at least one magnetic dipole which is arranged in the device to be located and rotates independently from the device, with the rotation axis of the dipole being fixed in relation to the housing and defining with one of the housing axis an angle which is >0°. The rotation axis extends hereby preferably perpendicular in relation to the dipole axis which connects the south and north poles.

“Fixed” is hereby to be understood within the scope of the invention that the relative position of the rotation axis can be unambiguously be determined at least in the (rotary) standstill of the drill head, either by physically secure it within the housing, or, for example, by evaluating the known rotation speed of the dipole about the rotation axis and the known rotation speed of the housing.

In accordance with the invention, it is not required for the rotation axis of the magnet and the respective housing axis to actually intersect. Rather, it is sufficient, when the two axes define the necessary angle of >0°, when projected upon a plane.

As the independently rotating magnet in relation to its rotation axis is arranged neither co-linear nor parallel to one of the housing axes, in particular the length axis, the position of the magnetic field, generated by the magnet, is transformed into an analyzable relative dependency in relation to the housing. The housing axis according to the invention may thus involve any housing axis; preferred, however, is the application of one of the main housing axes and especially preferred the housing length axis which also substantially corresponds to the movement direction of the device. In the following description, a reference to housing axis relates to the length axis of the device, without limiting the scope of the invention, as any other one of the housing axes may be substituted therefore.

The same effect may also be attained by rotating the magnetic dipole about an axis which, although co-linear or parallel (or also inclined) in relation to the length axis of the device, is not perpendicular to the north pole-south pole connection of the dipole so that the dipole executes a wobble motion. While this renders evaluation of the results more difficult, it leads, however, to the same result.

As the drill head rotates, the rotation axis of the magnet describes a double cone having a length axis in correspondence to the length axis of the housing or parallel thereto. The special case of a vertical disposition of the rotation axis of the magnet in relation to the length axis of the housing is also covered by the present invention and involves a circle which is described by the rotation axis of the magnet in relation to the length axis of the housing.

When the housing is at a standstill, the roll angle is determined by the piercing point of the rotation axis of the magnet through the housing jacket. As a double cone is defined, this method yields initially an ambiguous result, with the two determined results for the roll angle differing by precisely 180°. Using additional information, for example about the rough movement direction of the device, it can easily be determined which of the two single cones of the double cone and thus which of the two determined results is the correct one for the roll angle.

Such an isolation of the correct roll angle is not possible for the special case which is also covered by the invention and involves the perpendicular disposition of the rotation axis of the dipole in relation to the main housing axis. The outcome remains ambiguous with a deviation by 180°.

Advantageously, the rotating magnet is thus arranged within the housing such that the rotation axis of the magnet defines with the length axis of the housing an angle between 0° and 90°, excluding the respective limit values.

According to an advantageous embodiment, the magnetic field, i.e. the three time-dependent magnetic field components Hx(t), Hy(t) and Hz(t) of an external receiver, i.e. receiver outside the device, are detected. An evaluation unit connected with this receiver is then able to unambiguously and ambiguously determine the position, direction of the length axis, and/or the roll angle of the device on the basis of the determined magnetic field components.

The magnetic dipole is preferably a permanent magnet which can be used irrespective of an energy supply. As an alternative, and in particular when more transmitting power is demanded, the magnetic field may also be generated by an electromagnet.

According to an advantageous embodiment, the rotating magnet is driven by an electric drive. Electric drives are generally inexpensive, robust, and need little space. Moreover, supply of electric energy does normally not pose any problem.

Alternative embodiments may involve the supply of fluid for driving the magnet. Hydraulic fluid or compressed gas, for example compressed air, may hereby be used to operate a turbine of any kind or an otherwise hydraulic or pneumatic motor. Using hydraulic fluid for a drive may be advantageous especially when fluid is anyway supplied for any other purposed to the device. For example, drilling apparatuses oftentimes receive so-called flushing liquids for washing out drillings, for cooling the drill head, for increasing the cuffing power through addition of a hydraulic component, and for other purposes. Any drive combination (e.g. electric and hydraulic) may, of course, be used.

The respective device involved here is preferably a drill head, in particular a drill head of a controllable drilling system, a soil displacement hammer, percussion drilling device, bursting and/or expansion apparatuses, or a rod linkage or rod section, i.e. devices for trenchless drilling methods or pipe installation methods. The invention is however not limited to a use in this field. The systems and methods according to the invention, especially the apparatuses described above and hereinafter, can equally be utilized also for other scientific and technical fields which require precise detection and/or control of devices.

Preferred is the use of the instrument also for locating, determining of the axis direction, roll angle about a particular axis, and/or controlling of a medical, microsurgical, or endoscopic device.

According to a preferred embodiment, the device is provided with at least one separately operated drill or a cutting or impact apparatus.

When medical, microsurgical or endoscopic devices are involved, the device is provided with a needle, tubing, or tweezers. This is especially advantageous for performing surgical procedures, such as surgery on the brain, heart, or intestinal tract, implantation of artificial organs, tissue or vessels, catheters, probes, and pacemakers, or removal, destruction, or ablation of infectious or malignant tissue, bone and cartilage tissues, or treatment of calculosis.

As an alternative, or in addition, the instrument may be provided with one or more openings for discharge of a liquid. When the magnet provided in accordance with the invention is driven by the liquid flow, the flow rate and/or the discharge rate of the liquid or solution may further be measured.

According to a further preferred embodiment, the device includes an apparatus for generating and emitting light rays, laser beams, radioactive rays, sound waves, or ultrasonic waves.

According to an especially preferred embodiment, the device includes an apparatus for recording optical images or ultrasonic images.

As an alternative, or in addition, the device may include also apparatuses for emitting or recoding electric impulses or data.

A further advantageous embodiment is based on the possibility to vary the frequency or amplitude of the magnetic field. This may be applied to produce a frequency-selective amplification, to eliminate the impact of interfering external magnetic fields, or to distinguish devices from one another, when using several devices.

According to a preferred embodiment, a magnetometer is used for detecting the time-dependent magnetic field. Preferably used hereby is a three-axis magnetometer which measures the moving magnetic field, for example the magnetic moment, preferably its components in relation to the three spatial axes and ascertains preferably data, such as the amplitude, the relative phase and their frequency in the reference point. A flux-gate sensor may be used as three-axis magnetometer, for example.

The magnetometer can be moved as portable receiver in relation to the instrument, it may also be secured to a drilling device (bore rig) or on any area thereof.

According to the method of the invention for locating a device, at least one magnetic dipole, arranged in the area of the device, rotates about a rotation axis which extends at an angle of >0° in relation to the device length axis, the three time-dependent magnetic field components Hx(t), Hy(t) and Hz(t) are detected, and the position, the orientation of the device axis, and/or the roll angle of the device is calculated therefrom.

The present invention will now be described in greater detail with reference to the drawings.

The drawings show in

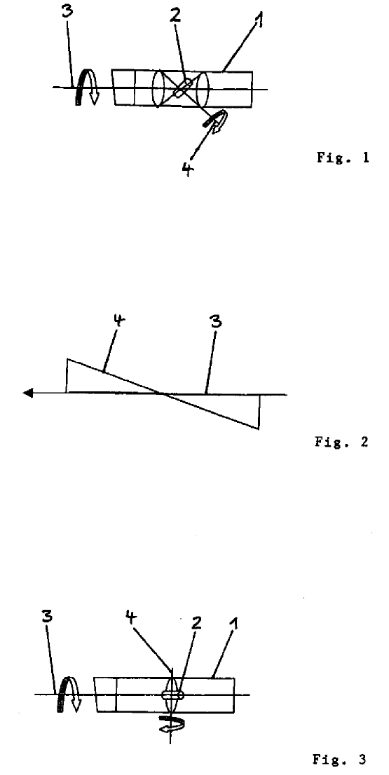

FIG. 1 a schematic illustration of an apparatus according to the invention,

FIG. 2 the graphic determination of the roll angle on the basis of a momentary recordation of a position of the rotation axis of the dipole, and

FIG. 3 an embodiment of an apparatus according to the invention in which the rotation axis of the dipole is positioned at a 90° angle in relation to the device length axis.

FIG. 1 shows a schematic illustration of an apparatus according to the invention. The apparatus includes a device housing 1 which rotates about its own length axis 3. A magnetic dipole 2 is arranged within the device housing 1 and also rotates about its own axis 4 to thereby produce a magnetic field which also rotates. This magnetic field can be detected by a (not shown) receiver and can be represented by the components of the magnetic field strength Hₓ, H_{y} and H_{Z} (of a randomly selected coordinate system). So long as the receiver does not rotate with the magnetic field, the components of the magnetic field strength are represented as time-dependent values Hx(t), Hy(t) and Hz(t). The position and alignment of the rotation axis 4 of the dipole 2 can be determined unambiguously from the change in time of the magnetic field.

The general determination of the orientation of the rotation axis is described in detail in German patent application having the application number 10 2004 058 272.6 so that the respective text of the description is incorporated in the instant specification by reference.

As a result of the superimposed rotation movements of device housing 1 and magnetic dipole 2, the rotation axis 4 of the dipole describes a double cone in space. When, on the other hands the rotation of the housing 1 is stopped, the alignment of the rotation axis 4 of the magnetic dipole is also maintained constant in the space. FIG. 2 shows this as projection in the drawing plane.

The defined position of the rotation axis 4 of the dipole within the housing 1 allows a simple determination of the roll angle f the (non-rotating) housing 1, whereby initially two values are provided which differ by 180°. Using a simple further information, for example the rough movement direction of the device, the “correct” value can however be distinguished from the “wrong” value.

This is not possible in the special case shown in FIG. 3. The magnetic dipole 2 is arranged within the housing 1 such that its rotation axis 4 describes an angle of 90° with the device length axis 3. Again, two values differing by 180° are received for the roll angle of the housing 1. Using an additional information involving the movement direction of the device does, however, not allow a distinction between the two values. The determination of the roll angle of the housing 1 thus remains ambiguous.

1.-19. (canceled)

20. An apparatus for locating a device, comprising:
a housing having a housing axis, and
at least one magnetic dipole arranged in the device and rotating independently of the device about a rotation axis which encloses a fixed angle>0° with respect to the housing axis.

21. The apparatus of claim 20, wherein the rotation axis of the magnetic dipole encloses an angle>0° and <90° with the housing axis.

22. The apparatus of claim 20, wherein the rotation axis of the magnetic dipole extends perpendicular to a line connecting a north pole and a south pole of the magnetic dipole.

23. The apparatus of claim 20, further comprising at least one external receiver which detects time-dependent magnetic field components of the rotating magnetic dipole.

24. The apparatus of claim 23, further comprising an evaluation unit connected to the external receiver and configured to determine from the detected time-dependent magnetic field components at least one of a position, a direction of the housing axis and a roll angle of the device.

25. The apparatus of claim 20, wherein the magnetic dipole is a permanent magnet.

26. The apparatus of claims 20, wherein the magnetic dipole is an electromagnet.

27. The apparatus of claim 20, further comprising an electric drive which drives rotation of the magnetic dipole.

28. The apparatus of claim 20, further comprising a fluidic drive which drives the magnetic dipole.

29. The apparatus of claim 20, wherein the device or a device tip comprises a drill bit, a cutting tool or an impact tool.

30. The apparatus of claim 20, wherein the device or a device tip includes at least one opening for discharge of a liquid.

31. The apparatus of claim 20, wherein the device or a device tip includes a unit for generating or emitting, or both, at least one of a light beam, a laser beam, radioactive rays, a sound wave and an ultrasonic wave.

32. The apparatus of claim 20, wherein the device or a device tip includes a unit for recording an optical image or an ultrasonic image, or both.

33. The apparatus of claim 20, wherein the device or a device tip includes a unit for emitting or recording, or both, at least one of electric impulses and electric data.

34. The apparatus of claim 28, wherein the device includes one or more openings for discharge of a liquid driving the fluidic drive, and determining a flow rate or exit speed of the discharged liquid from a rotation speed of the at least one dipole.

35. The apparatus of claim 20 constructed for execution of at least one of the tasks selected from the group consisting of generating endoscopic images for diagnostic purposes, generating electrical or electrophysiological data, examining blood vessels and treating vasoconstrictions, executing or monitoring surgical procedures on the brain, heart, or intestinal tract, implanting artificial organs or tissues, joint replacements, electromagnetic probes and pulse generators, pacemakers, tissue replacements and catheters, removal or destruction of gallstones or kidney stones, infectious tissue, tumor tissue, bone and joint materials, tailored administration of therapeutic substances to diseased tissue or tumor tissue, radiation of tumor tissue, determination of position, propulsion axle, and the roll angle in real time, measurement of a rotation speed, or a change in a rotation rate.

36. A system, comprising:
an apparatus for locating a device, said apparatus including a housing having a housing axis, and at least one magnetic dipole arranged in the device and rotating independently of the device about a rotation axis which encloses a fixed angle>0° with respect to the housing axis, and
a magnetometer configured to detect a magnetic field produced by the at least one magnetic dipole.

37. The system of claim 36, wherein the magnetometer is a three-axis magnetometer.

38. A method for locating a device, comprising the steps of:
arranging at least one magnetic dipole in an area of the device,
rotating the at least one magnetic dipole about a rotation axis extending at an angle>0° in relation to a longitudinal device axis,
detecting time-dependent magnetic field components produced by the at least one rotating magnetic dipole, and
calculating from the detected time-dependent magnetic field components at least one of a position, an orientation of the device axis, and a roll angle of the device.
